(19) United States
(12) Patent Application Publication
(10) Pub. No.: US 2005/0123273 A1
(43) Pub. Date: Jun. 9, 2005

(54) Trick play method of a digital storage medium and a digital storage medium drive

(76) Inventors: Sung-min Jeon, Suwon-si (KR); Jung-won Lee, Ansan-si (KR)

Correspondence Address: STANZIONE & KIM, LLP, 1740 N STREET, N.W., FIRST FLOOR, WASHINGTON, DC, 20036, US

(21) Appl. No.: 11/001,022

(22) Filed: Dec. 2, 2004

(30) Foreign Application Priority Data
Dec. 8, 2003 (KR) 2003-88778

(51) Int. Cl. H04N 5/783

(52) U.S. Cl. 386/68; 386/82

(57) ABSTRACT

A method of reproducing a sub-picture recorded on a digital storage medium in a trick play mode so that a desired reproduction location can be more accurately searched, and a digital storage medium drive thereof. The method includes detecting video frame data to be reproduced in the trick play mode and sub-picture data corresponding to the video frame data, from data read from the digital storage medium, decoding the detected video frame data and sub-picture data, respectively, and mixing the decoded video frame data with the decoded sub-picture data and outputting the mixed data.

### CROSS-REFERENCE TO RELATED APPLICATIONS

This application claims the priority of Korean Patent Application No. 2003-88778, filed on Dec. 8, 2003, in the Korean Intellectual Property Office, the disclosure of which is incorporated herein in its entirety by reference.

### BACKGROUND OF THE INVENTION

1. Field of the Invention

The present general inventive concept relates to a trick play method of a digital storage medium drive, and more particularly, to a trick play method of reproducing a sub-picture from a digital storage medium, and a digital storage medium drive.

2. Description of the Related Art

Digital storage media include a digital versatile disc (DVD), a digital video cassette recorder (DVCR), and a hard disc (HD). Data, i.e., video data and audio data, are recorded on a digital storage medium. Sub-picture data including on-screen display (OSD) information can be recorded selectively on the digital storage medium.

A digital storage medium drive has a normal reproduction function (mode) and a trick play function (mode) for the video data recorded on the digital storage medium. The trick play function includes a fast forward mode, a slow forward mode, a fast reverse mode, and a slow reverse mode for the video data recorded on the digital storage medium.

The fast forward mode is implemented by decoding only intra-coded pictures or predicted-coded pictures among the video data recorded on the digital storage medium, or by decoding only part of a first half of a group of pictures (GOP). The slow forward mode is implemented by repetitively decoding one picture a predetermined number of times according to an appropriate frequency, from the video data recorded on the digital storage medium. The fast reverse mode operates similarly to the fast forward mode, and the slow reverse mode operates similarly to the slow forward mode.

However, in existing digital storage medium drives, the sub-picture data is not reproduced when the trick play function is performed. Accordingly, in order to locate a desired sub-picture when the trick play function is performed, the existing digital storage medium drive should stop the trick play function and change the trick play function to a normal reproduction function.

In addition, when the trick play function is performed, only video frame data is reproduced, and therefore, if the contents of reproduced video frame data are similar, a reproduction location desired by a user cannot be accurately searched. For example, if the occupation of a hero is a telephone operator, and when the trick play function is performed, telephone receiving scenes are mainly displayed, the user may detect a wrong one from reproduction locations.

### SUMMARY OF THE INVENTION

The present general inventive concept provides a method of performing a trick play mode, the method including reproducing a sub-picture recorded on a digital storage medium so that a desired reproduction location of the sub-picture can be more accurately searched, and a digital storage medium drive thereof.

The present general inventive concept also provides a method of performing a trick play mode, video frame data and corresponding sub-picture data recorded on a digital storage medium together, and a digital storage medium drive thereof.

The present general inventive concept also provides a method of performing a trick play mode, the method including reproducing video frame data and on screen display (OSD) information recorded on a digital storage medium together, and a digital storage medium drive thereof.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing a trick play method comprising detecting video frame data to be reproduced in a trick play mode and sub-picture data corresponding to the video frame data, from data read from a digital storage medium, decoding the detected video frame data and sub-picture data, and mixing the decoded video frame data with the decoded sub-picture data and outputting the mixed data.

The foregoing and/or other aspects and advantages of the present general inventive concept may also be achieved by providing a digital storage medium drive with a trick play mode, the digital storage medium drive comprising a digital storage medium on which video frame data and sub-picture data are recorded, a buffer which stores the video frame data and the sub-picture data read out from the digital storage medium, a mixer which mixes the video frame data and the sub-picture data output from the buffer and outputs the mixed data, and a control unit which controls an output mode of the buffer when the trick play mode is performed, so that the video frame data to be reproduced and the sub-picture data corresponding to the video frame data are output together.

The foregoing and/or other aspects and advantages of the present general inventive concept may also be achieved by providing a digital storage medium drive with a trick play mode, the digital storage medium drive comprising a digital storage medium on which video frame data and sub-picture data are recorded, a digital signal processing unit which converts the video frame data and the sub-picture data read out from the digital storage medium into digital signals, a buffer which stores the digital signals corresponding to the video frame data and sub-picture data output from the digital signal processing unit, a video decoder which decodes the digital signals corresponding to the video frame data output from the buffer, a sub-picture decoder which decodes the digital signals corresponding to the sub-picture data output from the buffer, a mixer which mixes the decoded video frame data output from the video decoder and the decoded sub-picture data output from the sub-picture decoder and outputs the mixed data, and a control unit which controls an output mode of the buffer when the trick play mode is performed, so that the video frame data to be reproduced and the sub-picture data corresponding to the video frame data are output together.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram illustrating a digital storage medium drive according to an embodiment of the present general inventive concept;

FIG. 2 is a diagram illustrating a relationship between an intra-coded frame detection interval and sub-pictures corresponding detected infra frames when a trick play mode is a fast forward mode;

FIGS. 3A, 3B, and 3C are views illustrating a first screen and a second screen in a normal reproduction mode, and one frame screen obtained by mixing a detected intra-coded frame and a detected sub-picture when a trick play mode is a fast forward mode, respectively; and

FIG. 4 is a flowchart illustrating a trick play method of a digital storage medium drive according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

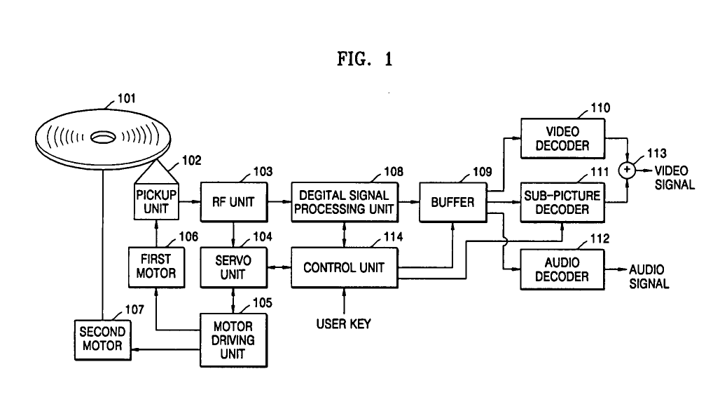

Referring to FIG. 1, a digital storage medium drive according to an embodiment of the present general inventive concept comprises a digital storage medium 101, a pickup unit 102, a radio frequency (RF) unit 103, a servo unit 104, a motor driving unit 105, a first motor 106, a second motor 107, a digital signal processing unit 108, a buffer 109, a video decoder 110, a sub-picture decoder 111, an audio decoder 112, a mixer 113, and a control unit 114.

The digital storage medium 101 is a medium, such as a DVD, a DVCR, and an HD. Data, i.e., video frame data, audio data, and sub-picture data, are recorded on the digital storage medium 101. The sub-picture data can be selectively recorded. The sub-picture data can include on-screen display (OSD) information.

The pickup unit 102 reads out the data recorded on the digital storage medium 101. That is, the pickup unit 102 reads out the video frame data, the audio data, the sub-picture data, additional information, and the like recorded on the digital storage medium 101, and outputs the read data.

The RF unit 103 demodulates the read data and information output from the pickup unit 102 into an RF signal and outputs the RF signal.

The servo unit 104 generates a control signal to control operations of the first motor 106 and the second motor 107, according to a focus error (FE) signal and tracking error (TE) signal output from the RF unit 103. The motor driving unit 105 drives the first motor 106 and the second motor 107 according to the control signal generated by the servo unit 104.

The first motor 106, controlled by the motor driving unit 105, moves a location of the pickup unit 102 horizontally with respect to the digital storage medium 101. The second motor 106, controlled by the motor driving unit 105, rotates the digital storage medium 101.

The digital signal processing unit 108 converts the RF signal output from the RF unit 103 into a digital signal. That is, the digital signal processing unit 108 converts the video frame data, the audio data, and the sub-picture data into respective digital signals and outputs the digital signals corresponding to the video frame data, the audio data, and the sub-picture data.

The buffer 109 temporarily stores the video frame data, the audio data, and the sub-picture data output from the digital signal processing unit 108, and under the control of the control unit 114, outputs the stored video frame data, sub-picture data, and audio data.

The video decoder 110 decodes the video frame data output from the buffer 109 and outputs the decoded data.

The sub-picture decoder 111 decodes the sub-picture data output from the buffer 109 and outputs the decoded data. If a trick play mode is a fast forward mode, and there are a plurality of sub-pictures corresponding to one video frame, the sub-picture decoder 11 shifts the respective reproduction locations of data of the plurality of sub-pictures and then decodes the shifted data of the plurality of sub-pictures under the control of the control unit 114. For example, when the trick play mode is in an n times fast forward reproduction mode or in an n times fast reverse reproduction mode, the sub-picture decoder 111 shifts an absolute time location of the sub-picture data to a predetermined location and then decodes the shifted data. The predetermined location is determined based on the absolute time location of the video frame data corresponding to the sub-picture data.

The audio decoder 112 decodes the audio data output from the buffer 109 and outputs the decoded data.

The mixer 113 mixes the decoded video frame data output from the video decoder 110 and the decoded sub-picture data output from the sub-picture decoder 111 and outputs the mixed data, so that the video frame data and sub-picture data can be displayed in one frame screen.

The control unit 114 controls operations of the servo unit 104, the digital signal processing unit 109, the buffer 110, and the sub-picture decoder 112 according to a user key input from a user.

If the trick play mode is set, the control unit 114 sends a control signal to the servo unit 104 so that the digital storage medium 101 is rotated according to a set speed of the trick play mode and that the data recorded on the digital storage medium 101 can be read out. In response to the control signal, the servo unit 104 generates a servo control signal and outputs the servo control signal to the motor driving unit 105 so that the first motor 106 and the second motor 107 operate appropriately at the set speed.

In addition, if the trick play mode is set, the control unit 114 controls an output mode of the buffer 110 so that the video frame data to be reproduced and the sub-picture data corresponding to the video frame data are output together from the video frame data read out from the digital storage medium 101.

If the trick play mode is the fast forward mode, according to the speed set by the input user key, the control unit 114 calculates a detection interval to detect the video frame data to be reproduced from the video frame data read out from the digital storage medium 101. Based on the calculated detection interval, the control unit 114 designates the video frame data and the sub-picture data to be output from the buffer 109. The buffer 109 outputs the designated video frame data and sub-picture data, respectively.

If there are a plurality of sub-pictures corresponding to one video frame to be reproduced, the control unit 114 controls the sub-picture decoder 111 so that the plurality of sub-pictures can be displayed in a one frame screen.

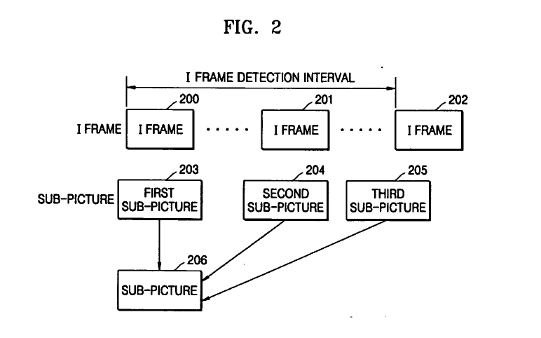

That is, if the detection interval of the video frame data to be reproduced is set based on an interval between intra-coded frames as shown in FIG. 2, and the sub-pictures existing between an intra-coded frame 200 currently reproduced and an intra-coded frame 202 to be reproduced next are first through third sub-pictures 203 through 205 as shown in FIG. 2, the sub-pictures corresponding to the intra-coded frame 200 currently reproduced are the first through third sub-pictures 203 through 205.

Accordingly, the control unit 114 controls the output mode of the buffer 109 so that the sub-picture data of the first through third sub-pictures 203 through 205 can be output when the video frame data of the intra-coded frame 200 is output from the buffer 109.

In order that the data of the first through third sub-pictures 203 through 205 can be displayed on the one frame screen, the sub-picture decoder 111 shifts absolute time location data of each sub-picture to predetermined locations, performs decoding for the shifted data of each sub-picture, and generates a sub-picture 206 of FIG. 2. In FIG. 2, an I frame 201 is an intra-coded frame skipped during the fast forward mode.

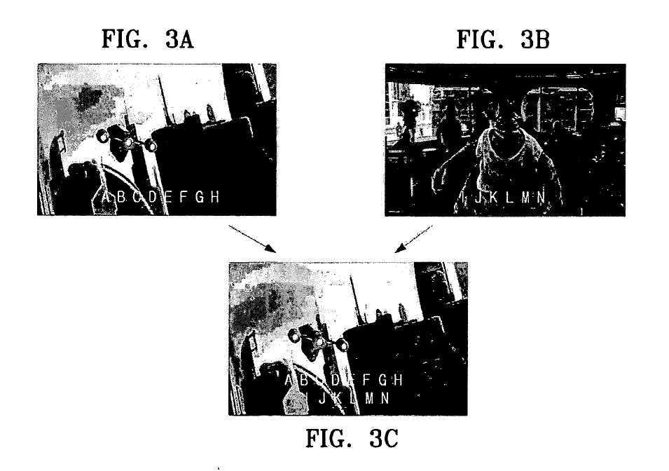

By performing the trick play function described above, a one frame screen as shown in FIG. 3C can be displayed. FIGS. 3A, 3B, and 3C are views illustrating a first screen and a second screen in a normal reproduction mode, and a one frame screen obtained by mixing a detected intra-coded frame of the first frame of FIG. 3A and a detected sub-picture of sub-pictures of the first and second frames of FIGS. 3A and 3B, respectively, when a trick play mode is a fast forward mode. In the first screen of FIG. 3A, first video frame data is displayed, and first sub-picture data, for example, “A B C D E F G H,” is displayed in a reproduction location of the first screen in the normal reproducing mode. In the second screen of FIG. 3B, second video frame data is displayed, and second sub-picture data, for example, “I J K L M N,” is displayed in a reproduction location of the second screen in the normal reproducing mode. The reproduction locations of the first and second sub-picture data may be identical to each other. FIG. 3C shows a case where there are two sub-pictures corresponding to one video frame to be reproduced. That is, the intra-coded frame of FIG. 3B is an intra-coded frame to be skipped due to the fast forward reproduction. The reproduction location of the first sub-picture of FIG. 3A is shifted to a second reproduction location as shown in FIG. 3C so that the second sub-picture of FIG. 3B is displayed in the original reproduction location. Accordingly, the first and second sub-pictures of FIGS. 3A and 3B, for example, “A B C D E F G H” and “I J K L M N,” are respectively displayed in the original reproduction location and the shifted reproduction location on the one frame screen together with the first video frame data as shown in FIG. 3C.

If the trick play mode is a slow forward mode, the control unit 114 calculates the repetitive reproduction period of the video frame data to be reproduced according to the speed set by the input user key. The control unit 114 controls the output mode of the buffer 109 so that during the calculated repetitive reproduction period, identical frame data and identical sub-picture data are output from the buffer 109.

Whenever the video frame data and the sub-picture data are output from the buffer 109, the video decoder 110 and the sub-picture decoder 111 decode input data and output the decoded data.

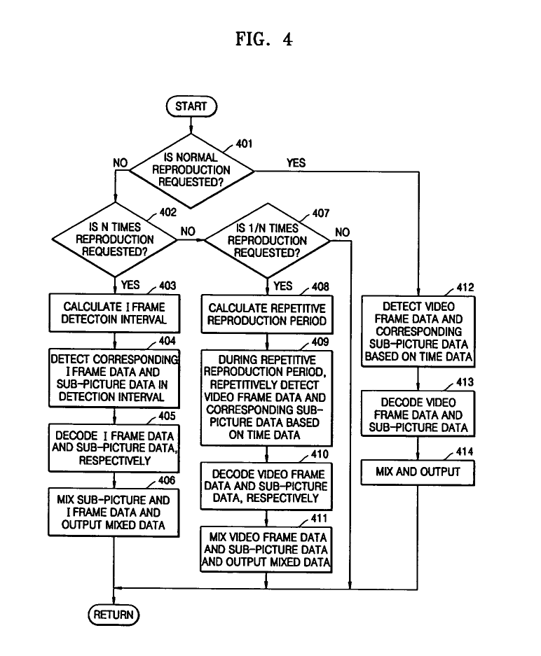

FIG. 4 is a flowchart illustrating a trick play method of a digital storage medium according to another embodiment of the present general inventive concept.

If a user key is input, the control unit 114 determines whether or not normal reproduction is requested in operation 401. If it is determined in the operation 401 that normal reproduction is not requested, it is determined whether or not n times fast reproduction is requested in operation 402. The n times fast reproduction is a fast reproduction mode in the trick play mode. The fast reproduction mode may be any one of a fast forward mode and a fast reverse mode.

If it is determined in the operation 402 that the n times fast reproduction is requested, a detection interval of intra-coded frames to be reproduced according to the n times fast reproduction is calculated in operation 403. The control unit 114 detects intra-coded frame data to be reproduced based on the calculated detection interval, and sub-picture data in the detected interval, respectively, in operation 404.

The detected intra-coded frame data and sub-picture data are decoded respectively in operation 405. At this time, if there are a plurality of detected sub-pictures, reproduction locations of data of the plurality of sub-pictures are shifted to a predetermined location and then the sub-picture data corresponding to the shifted plurality of sub-pictures are decoded.

In operation 406, the decoded sub-picture data and intra-coded frame data are mixed and output.

Meanwhile, if it is determined in the operation 402 that the user key does not request the n times fast reproduction, it is determined whether or not 1/n times fast reproduction is requested in operation 407. The 1/n times fast reproduction is a slow reproduction mode in the trick play mode. The slow reproduction mode may be any one of a slow forward mode and slow reverse mode. If it is determined in the operation 407 that the 1/n times fast reproduction is requested, the control unit calculates a repetitive reproduction period according to a determined speed in operation 408. In operation 409, during the repetitive reproduction period, video frame data to be reproduced and sub-picture data corresponding to the video frame data are repetitively detected from the data read from the digital storage medium 101, based on absolute time data of the video frame data in the digital storage medium 101. Accordingly, the control unit 114 controls the output mode of the buffer 109 so that identical video frame data and sub-picture data corresponding to the video frame data can be output from the buffer 109 during the repetitive reproduction period.

In operation 410, whenever the video frame data and the sub-picture data corresponding to the video frame data are output, the video frame data and the sub-picture data are decoded respectively.

In operation 411, the decoded video frame data and sub-picture data are mixed, and the mixed data are output so as to be displayed in one frame screen.

If it is determined in operation 407 that the user key does not request the 1/n times fast reproduction, the process unit 114 returns to the operation 401.

If it is determined in operation 401 that the user key requests normal reproduction, in step 412, the control unit 114 sequentially outputs the video frame data and the sub-picture data corresponding to the video frame data read out from the digital storage medium 101, based on absolute time data in the digital storage medium 101.

In operation 413, the output video frame data and sub-picture data are decoded respectively, and in operation 414, the decoded video frame data and sub-picture data are mixed and output.

According to the present general inventive concept as described above, when a trick play of a digital storage medium drive is performed, video data and sub-picture data corresponding to the video data are mixed and reproduced. By doing so, the reproduction mode of the digital storage medium drive does not need to be changed to search for a desired sub-picture when the trick play is performed. In addition, the user can search for a desired reproduction location by further referring to a sub-picture, such that the desired reproduction location can be searched more accurately.

The present general inventive concept can be realized as a method, an apparatus, and a system. When the present general inventive concept is manifested in computer software, components of the present general inventive concept may be replaced with code segments that are necessary to perform the required action. Programs or code segments may be stored in media readable by a processor, and transmitted as computer data that is combined with carrier waves via a transmission media or a communication network.

The media readable by a processor include anything that can store and transmit information, such as, electronic circuits, semiconductor memory devices, ROM, flash memory, EEPROM, floppy discs, optical discs, hard discs, optical fiber, radio frequency (RF) networks, etc. The computer data also includes any data that can be transmitted via an electric network channel, optical fiber, air, electro-magnetic field, RF network, etc.

In an embodiment of the present general inventive concept, a computer readable storage medium may contain a trick play method which includes detecting video frame data to be reproduced in a trick play mode and sub-picture data corresponding to the video frame data, from data read from a digital storage medium, decoding the detected video frame data and sub-picture data, and mixing the decoded video frame data with the decoded sub-picture data and outputting the mixed data. The method may include storing first and second video frame data and first and second sub-picture data to be displayed on a reproduction location of a screen with the first and second video frame data, respectively, and mixing the first video data and the first and second sub-picture data in a trick play mode.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A trick play method comprising:
detecting video frame data to be reproduced in a trick play mode and sub-picture data corresponding to the video frame data, from data read from a digital storage medium;
decoding the detected video frame data and sub-picture data; and
mixing the decoded video frame data with the decoded sub-picture data and outputting the mixed data.

2. The method of claim 1, wherein if the trick play mode is a fast reproduction mode, the detecting of the video frame data and the sub-picture data comprises:
calculating a detection interval of the video frame data to be reproduced according to a set reproduction speed of the fast reproduction mode; and
detecting at least one or more sub-picture data located in a reproduction location of the video frame data to be currently reproduced and a reproduction location of the video frame data to be reproduced after the current video frame data, the reproduction locations of the at least one or more sub-picture data being determined by the detection interval.

3. The method of claim 2, wherein in detecting the sub-picture data, data corresponding to all sub-pictures located in the reproduction location of the video frame data to be currently reproduced and the reproduction location of the video frame data to be reproduced after the current video frame data, are detected as the at least one or more sub-picture data corresponding to the video frame data.

4. The method of claim 3, wherein in decoding the sub-picture data, the reproduction location of data of at least one of the sub-pictures is shifted and decoded so that the data of the all sub-pictures are displayed together in one frame screen.

5. The method of claim 2, wherein the video frame data to be reproduced is an intra-coded frame.

6. The method of claim 1, wherein if the trick play mode is a slow reproduction mode, the detecting of the video frame data and the sub-picture data comprises:
calculating a repetitive reproduction period of the video frame data to be reproduced according to a set reproduction speed of the slow reproduction mode; and
repetitively detecting identical video frame data and sub-picture data during the repetitive reproduction period.

7. The method of claim 1, wherein the detecting of the video frame data and the sub-picture data comprises:
detecting first video frame data and second video frame data;
detecting first sub-picture data and second sub-picture data corresponding to the first video frame data and the second video frame data, respectively; and
detecting the first video frame data as the video frame data and the first sub-picture data and the second sub-picture data as the sub-picture data when the trick play mode is a fast reproduction mode.

8. The method of claim 7, wherein the decoded video frame data does not include the second video frame data.

9. The method of claim 7, wherein the detecting of the video frame data and the sub-picture data comprises:
detecting third video frame data and third sub-picture data corresponding to the third video frame data; and
detecting the first video frame data and the first, second, and third sub-picture data as the video frame data and the sub-picture data, respectively.

10. The method of claim 9, wherein the decoded video frame data does not include the second and third video frame data.

11. The method of claim 1, wherein the data comprises first video frame data and second video frame data, and first sub-picture data and second sub-picture data to be displayed on a reproduction location of a first and a second screens together with the first video frame data and the second video frame data, respectively, and the video frame data and the sub-picture data comprise the first frame data and the first and second sub-picture data to be displayed on a one screen.

12. The method of claim 1, wherein the mixing of the decoded video frame data and sub-picture data comprises generating a second reproducing location of a one frame screen so that the first sub-picture data and the second sub-picture data are located in the reproduction location and the second reproduction location, respectively.

13. A digital storage medium drive comprising:
a buffer which stores video frame data and sub-picture data corresponding to the video frame data, from data read out from a digital storage medium;
a decoder which decodes the video frame data and the sub-picture data;
a mixer which mixes the decided video frame data and sub-picture data output from the decoder, and outputs the mixed data; and
a control unit which controls an output mode of the buffer in the trick play mode so that the video frame data to be reproduced and the sub-picture data corresponding to the video frame data are output together.

14. The digital storage medium drive of claim 13, wherein if the trick play mode is a fast reproduction mode, the control unit calculates a detection interval of the video frame data to be reproduced according to a set reproduction speed of the fast reproduction mode, and designates the video frame data and the sub-picture data to be output from the buffer according to the calculated detection interval.

15. The digital storage medium drive of claim 14, wherein the video data comprises current video frame data and next video frame data, and the control unit controls an output mode of the buffer according to the calculated detection interval so that data corresponding to all sub-pictures located between the current video frame data to be output and the next video frame data are output as the sub-picture data corresponding to the current video frame data.

16. The digital storage medium drive of claim 13, wherein if the trick play mode is a slow reproduction mode, the control unit calculates a repetitive reproduction period of the video frame data to be reproduced according to a set reproduction speed of the slow reproduction mode and controls an output mode of the buffer so that identical video frame data and sub-picture data are output from the buffer during the repetitive reproduction period.

17. The digital storage medium drive of claim 13, wherein the video frame data and the sub-picture data stored in the buffer comprise first and second video frame data and first and second sub-picture data corresponding to the first and second video frame data, respectively, and the decoder decodes the first video frame data and the first and second sub-picture data as the decoded video data and sub-picture data, respectively.

18. The digital storage medium drive of claim 13, wherein the buffer stores first and second video frame data to be displayed on a first and a second screens, and first and second sub-picture data to be displayed in a reproduction location of the first and second screens together with the first and second video frame data, respectively, and the mixer mixes the first video frame data and the first and second sub-picture data to be displayed on a one frame screen.

19. The digital storage medium drive of claim 18, wherein the first sub-picture data is displayed on the reproduction location of the one frame screen, and the second sub-picture data is displayed on a second reproduction location of the one frame screen.

20. A digital storage medium drive with a trick play function comprising:
a digital signal processing unit which generate video frame data and sub-picture data read out from a digital storage medium;
a buffer which stores the video frame data and the sub-picture data output from the digital signal processing unit;
a video decoder which decodes the video frame data output from the buffer;
a sub-picture decoder which decodes the sub-picture data output from the buffer;
a mixer which mixes the decoded video frame data output from the video decoder and the decoded sub-picture data output from the sub-picture decoder, and outputs the mixed data; and
a control unit which when a trick play mode is performed, controls an output mode of the buffer so that the video frame data to be reproduced and the sub-picture data corresponding to the video frame data are output together.

21. The digital storage medium drive of claim 20, wherein if the trick play mode is a fast reproduction mode, the control unit calculates a detection interval of the video frame data to be reproduced according to a set reproduction speed of the fast reproduction mode, and designates the video frame data and the sub-picture data to be output from the buffer according to the calculated detection interval.

22. The digital storage medium drive of claim 21, wherein if the sub-picture data output from the buffer comprises data of a plurality of sub-picture data, the control unit controls the sub-picture decoder so that the data of the plurality of sub-picture data are displayed together in one frame screen, and controls the sub-picture decoder to shift a reproduction location of the data of at least one of the plurality of sub-picture data and then decodes the shifted sub-picture data.

23. The digital storage medium drive of claim 20, wherein if the trick play mode is a slow reproduction mode, the control unit calculates a repetitive reproduction period of the video frame data to be reproduced according to a set reproduction speed of the slow reproduction mode and controls an output mode of the buffer so that identical video frame data and sub-picture data are output from the buffer during the repetitive reproduction period.

24. A trick play method comprising:
storing first and second video frame data and first and second sub-picture data to be displayed on a reproduction location of a screen with the first and second video frame data, respectively; and
mixing the first video data and the first and second sub-picture data in a trick play mode.

25. The method of claim 24, wherein the mixing of the first video frame data and the first and second sub-picture data comprises:
locating the first sub-picture data in the reproduction location of the screen and the second sub-picture data in a second reproduction location of the screen.

26. A digital storage medium drive comprising:
a buffer which stores first and second video frame data and first and second sub-picture data to be displayed on a reproduction location of a screen with the first and second video frame data, respectively; and
a mixer which mixes the first video frame data and the first and second sub-picture data in a trick play mode.

27. The digital storage medium drive of claim 26, further comprising:
a decoder which decodes the first sub-picture data to be located in a first reproduction location of a screen and decodes the second sub-picture data to be located in a second reproduction location of the screen.

28. A computer readable storage medium containing a trick play method, the method comprising:
detecting video frame data to be reproduced in a trick play mode and sub-picture data corresponding to the video frame data, from data read from a digital storage medium;
decoding the detected video frame data and sub-picture data; and
mixing the decoded video frame data with the decoded sub-picture data and outputting the mixed data.

29. A computer readable storage medium containing a trick play method, the method comprising:
storing first and second video frame data and first and second sub-picture data to be displayed on a reproduction location of a screen with the first and second video frame data, respectively; and
mixing the first video data and the first and second sub-picture data in a trick play mode.
